(19) United States
(12) Patent Application Publication
(10) Pub. No.: US 2015/0204894 A1
(43) Pub. Date: Jul. 23, 2015

(54) RELATIVE ROUTING PRIORITY FOR TEST REQUESTS

(71) Applicant: SIEMENS HEALTHCARE DIAGNOSTICS INC., Tarrytown, NY (US)

(72) Inventors: Gerard Killeen, Nenagh County Tipperary (IE); Ciaran Murray, Athboy Meath (IE); Frank Wedgeworth, Dumcondra Dublin 9 (IE)

(73) Assignee: Siemens Healthcare Diagnostics Inc., Tarrytown, NY (US)

(21) Appl. No.: 14/417,021

(22) PCT Filed: Jul. 25, 2013
(86) PCT No.: PCT/US13/52017

§ 371 Date: Jan. 23, 2015

Related U.S. Application Data
(60) Provisional application No. 61/676,055, filed on Jul. 26, 2012.

(51) Int. Cl. G01N 35/00

(52) U.S. Cl. CPC G01N 35/0095

(57) ABSTRACT

Workflows for testing in automated laboratory environment are managed and controlled to permit prioritization and dependencies to be implemented for individual tests. Test groups can be specified to include analytical and non-analytical test requests. Instrument test status and/or sample location is used to determine whether workflow criteria is met. Each test can be assigned a completion criteria, which can foe used to retake other tests or operations contingent on the outcome of another test. Automation of the laboratory is enhanced with greater flexibility in controlling testing.

### STATEMENT REGARDING FEDERALLY SPONSORED RESEARCH OR DEVELOPMENT

(Not Applicable)

### BACKGROUND

The present disclosure relates generally to laboratory automation environments, and relates more particularly to routing of test requests in laboratory automation environments based on relative priority.

Analytical tests are carried out on laboratory equipment, where laboratory equipment can be purposed for certain types of tests. For example, an immunoassay instrument may be provided for infectious disease tests on aspirations, while chemistry instruments may be provided for chemical tests on a same or different sample aspiration. It is often desirable to fully complete infectious disease tests at an immunoassay instrument for a given sample prior to commencing any other tests for that sample on any other instruments, such as chemistry instruments. For example, it may be desirable to have the infectious disease test for a sample fully resulted prior to determining if tests for that sample are to be run on chemistry instruments. This sequence of tests may also be desired to avoid contamination of samples from tests performed by chemistry instruments.

Sequences of tests performed on the above mentioned instruments are often handled manually by a technician. Some laboratory instrumentation automation systems can operate on a sequence of samples, which are handled through automation for the given instrument. However, the instrument does not typically provide completion criteria of the given test that can be used with other instruments.

Laboratory information systems (LIS) typically coordinate information exchange between laboratory instruments. LIS is typically used to communicate various data between instruments, such as status data or the occurrence of events.

A laboratory automation system (LAS) typically integrates laboratory instruments to function as a coordinated system. The laboratory instruments are typically connected via a computer network to a centralized computer system that can run process management software for controlling the instruments and sample runs. An LAS may use LIS in performing functions for management of laboratory instruments. However, known process management software generally does not involve priority scheduling among different instruments with potential dependencies on the outcomes of the tests being conducted at the various instruments.

### BRIEF SUMMARY

The present disclosure provides systems and methods for managing workflows in automated laboratory environments. The managed workflows provided by the present disclosure support the prioritized gradual release of groups of analytical and non-analytical test requests for samples in a laboratory automation system. The managed workflows can be specified in accordance with desired criteria, which can be implemented in the form of workflow or business logic. The implementation can include prioritization and completion criteria for given tests, which can be used as contingency criteria for performing further tests.

The managed workflows provided by the present disclosure include non-analytical test that can be defined in accordance with a desired workflow. Such non-analytical test can include, but are not limited to, operations such as diverting test samples to particular locations within the laboratory automation environment, parking samples at specified location, and sorting samples in accordance with given criteria. The managed workflows can be configured in accordance with desired criteria that can be specified in accordance with the configuration of the laboratory automation system. The managed workflows of the present disclosure can work with or within existing laboratory systems, including process management software, LAS and/or LIS.

Samples identified within the managed workflows of the present disclosure can be assigned various priorities with respect to the overall test to be conducted, and with respect to the laboratory instruments to be used for conducting tests. Accordingly, priority routing of samples among the different laboratory instruments can be organized and managed in accordance with the present disclosure, so that dependencies based on desired instruments and priority can be accommodated to efficiently managed workflows.

The present disclosure is applicable in non-automated environments as well as automated environments, and can be used to instruct laboratory personnel on sequences of testing based on desired workflow configurations, so that manual testing implemented workflows can be effectively achieved with greater efficiency. The present disclosure provides a user interface for specifying workflow configurations, as well as for observing statuses of sample tests. The user interface permits configuration and status observations to be obtained intuitively and with greater transparency to permit complex workflows to be designed and implemented with greater ease. The user interface has access to a database that can record and store workflow configurations that can be specific to the laboratory automation system configuration or specific instruments. Sample tests can be arranged in test groups as an organizational tool, for example as a template. A number of test groups can be scheduled for execution simultaneously, so that test within the test groups can be executed in order as the associated instrument becomes available. Multiple tests can thus be scheduled for simultaneous execution as part of different test groups. The logic provided in the platform of the present disclosure permits tests to be scheduled and executed as resources become available, based on an overall prioritization for the tests based on the priority of the tests and the test groups to which the tests belong. Accordingly, a test group that is currently being processed for a given sample that does not occupy a given instrument allows that instrument to be an available resource for later scheduled or lower priority tests or test groups. The platform logic tracks the status of the tests and test groups, as well as the scheduling and priority of the tests and test groups, so that execution of tests can be optimized for efficiency, or for other criteria. The platform logic also provides significant flexibility for the user to schedule and prioritize tests, and also permits test results and/or sample location to be used as contingent criteria for determining further tests to be scheduled, prioritized or executed.

Test specifications can be implemented based on logical sequences, such as prioritization of tests, order or sequencing of tests, completion criteria for a test or a group of tests or work group or collection of work groups. Workflows can be specified as using such logic and status criteria, including completion criteria for portions of a series of tests. For example, a workflow can be specified to execute a first test or series of tests, and wait for the test or series of test to be fully resulted prior to initiating an additional sequence of tests.

### BRIEF DESCRIPTION OF THE SEVERAL VIEWS OF THE DRAWINGS

Exemplary embodiments of the present disclosure are described in greater detail below, with reference to the accompanying drawings, in which:

FIG. 1 is a diagram of a laboratory automation system;

FIG. 2 is a flowchart illustrating creation of a test group in accordance with an exemplary embodiment of the present disclosure; and

FIG. 3 is a flowchart illustrating test group processing in accordance with an exemplary embodiment of the present disclosure.

### DETAILED DESCRIPTION

The present disclosure provides systems and methods for managing workflows in an automated laboratory environment. Users can specify detailed workflows with prioritized sample handling to permit efficient and automated implementation of instrument tests. The present disclosure provides for groups of analytical and non-analytical tests, which non-analytical tests can take the form of sample movement, sorting or location identification related operations.

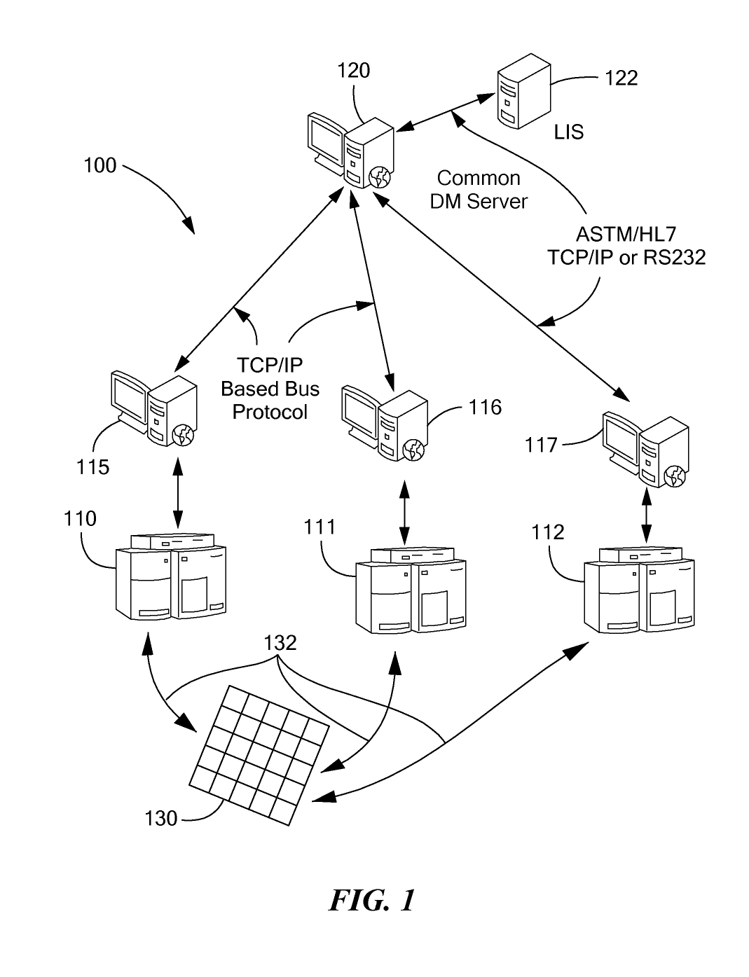

Referring now to FIG. 1, a network 100 of devices associated with laboratory test equipment is illustrated. Network 100 includes diagnostic instruments 110, 111 and 112, which may be different types or the same type of medical diagnostic instrument, which may be managed within a workstation configuration through computer workstations 115, 116 and 117, respectively. Computer workstations 115-117 permit a user to interact with respective instruments 110-112 and manage data and control information associated with instruments 110-112. In addition, or alternatively, workstations 115-117 can provide an interface for setting up respective instruments 110-112, which instruments are then controlled by other devices in network 100 to obtain an automated laboratory environment. While three instruments 110-112 and respective workstations 115-117 are shown, it should be understood that any number of instruments and attendant workstations may be provided in accordance with the present disclosure. For example, the number of instruments and workstations that can be supported by a laboratory automation system (LAS) may be provided, as well as additional instruments or devices that support manual or offline testing or handling of samples.

Workstations 115-117 can communicate with data management (DM) server 120 over network links that may implement different types of protocols. For example, the links between workstations 115, 116 and DM server 120 can be implemented as a TCP/IP based bus protocol, while the link between workstation 117 and DM server 120 can carry messages based on the ASTM or HL7 standards using a TCP/IP transport protocol or an RS232 serial link. This type of communication link is somewhat specific in nature to the exchange of information in the medical services community. This type of communication link may also be used between DM server 120 and a laboratory information system (LIS) 122 that supports various types of laboratory processes in the medical services industry. LIS 122 can provide or generate status information, and the LAS can provide location information for samples in the LAS. The connectivity and configuration of network 100 is provided as an example, and may be varied depending upon instrument configuration and accessibility to data as desired. For example, workstations 115-117 may be omitted or integrated into instruments 110-112 to permit direct communication with DM server 120.

DM server 120 can implement a platform to employ systems and methods in accordance with the present disclosure. According to one example, DM server 120 may implement a version of CentraLink™ data management system by Siemens® AG. The instrument management software implemented on workstation 115, 116, 117 may be specific to the associated instruments 110, 111, 112, while also providing access to common core features for automation implemented with DM server 120. According to some exemplary embodiments, an instrument workstation, such as workstations 115, 116, 117 can provide instrument status that includes test sample status for samples that are being run through the instrument. This status information may be managed by LIS 122.

In an LAS, instruments 110-112 may be interconnected with a sample handling system, which is generally illustrated in network 100 with a sample tray 130 that can travel on prescribed routes 132. Samples are typically tracked in the sample handling system, so that the lane and position in a lane of a sample is observed and/or recorded. The sample handling system can determine or note when a sample is removed from a given station, or when samples are introduced at a given station. In addition, the sample handling system can sort or park samples according to a given criteria that can be provided by DM server 120, for example.

The LAS that can be implemented with network 100 can accept test specifications for a test to be run on a particular sample on a particular instrument. Various data is provided to the LAS in the test specifications, such as a type of test, an action code for the test, and other administrative data to permit the LAS to accept and execute the test. LIS 122 generates status information on the tests or instruments, which is made available to the various components in network 100.

In accordance with the present disclosure, DM server 120 can implement a platform to support the prioritized gradual release of groups of analytical and non-analytical (sort, park) test requests for samples in the LAS. In accordance with the present disclosure, analytical tests can be performed until a user defined completion criteria is met. Each test can have associated completion criteria that can define when the test is advanced to a defined result before further tests or activities for a sample are permitted. The defined result can be specified in terms of meeting values for statuses in relation to the test, instrument, devices or activities with regard to a sample. Non-analytical tests (e.g. park and sort tests) also can have completion criteria. Users can configure “relative routing” criteria for test requests in order have the desired workflows automated by software being run on DM server 120, sometimes referred to as “middleware.”

The gradual release of test requests to instruments can also be utilized in non-automation environments. An example of usage in automation is to have infectious disease testing performed on samples and be resulted before doing Chemistry testing, in order to avoid any possibility of contamination and to ensure there is sufficient sample volume to complete the tests.

According to the present disclosure, users can control the order in which tests on a given sample are conducted and completed, as well as control the criteria used to determine when those tests are completed. An example is to conduct aspirations at an immunoassay instrument for infectious disease tests and have those tests fully resulted, before any other tests on any other instrument are commenced. The user can specify the completion criteria for the test, which can call for thee runs of the individual tests at the immunoassay instrument, for example. The completion criteria can be used to permit or prevent other test events, such as test execution, scheduling or completion.

According to an exemplary embodiment of the present disclosure, desired tests for a given sample are collected into user defined groups. These groups are ranked in relative priority order, with the first having the highest priority order, for example. Groups of test requests can also be prioritized in their order of execution as they are provided to the LAS. For example, the test groups can be queued up so that the sequence of the queue acts as a priority implementation. Alternatively, or in addition, groups can be assigned priorities to permit higher priority groups to be executed before lower priority groups. Once the user defined completion criteria from the previous group is met, the next group can be submitted for processing in accordance with the established group priority.

An example of the completion criteria for analytical tests is that the test has been successfully aspirated at an instrument or that a validated result has been generated for that test group at an instrument. An example of the completion criteria for non-analytical tests is where a sample has been routed to a sort area on a tray, typically for off-track processing, and that tray has been removed and the sample subsequently returned to the LAS.

The presently disclosed systems and methods permit instrument-based testing to be fully automated and further permits certain workflows that were not possible or required significant user involvement in prior systems. The user can determine the specific test groups to be used, the tests specified within the groups and the associated completion criteria, which can be based on complex logic, to achieve a desired testing configuration for the laboratory and test sample.

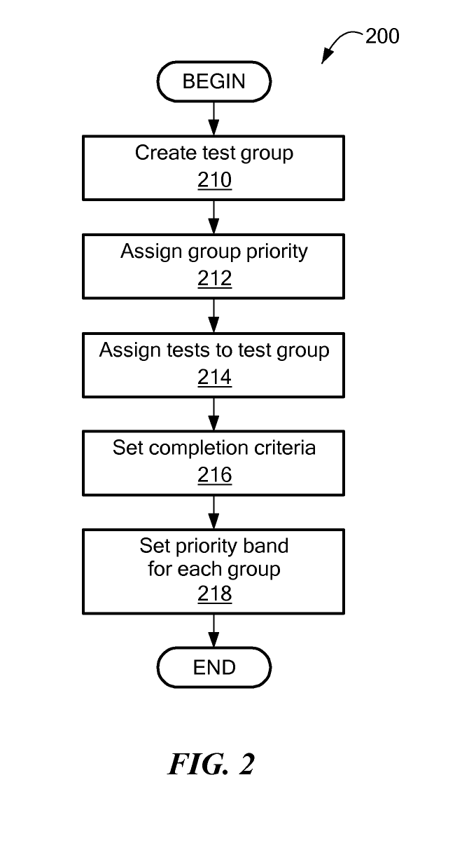

Referring now to FIG. 2, a flowchart 200 illustrates a process for setting up a test procedure for submission to the laboratory automation system (LAS). The user creates a test group as an initial step, as illustrated in block 210. The test group can be structured in accordance with a number of different formats, for example, as a table in which each row represents a test and each column represents some criteria related to the test.

Once the user creates a test group, a priority can be assigned to the test group, via the priority band, to permit relative prioritized implementation of test groups in the LAS. The assignment of test group priority is illustrated in block 212.

The user can then assign tests to the test group, such as by selecting a row of a table that represents a test, and inputting or selecting a test to be represented by that row. The assignment of tests to the test group is illustrated in block 214. Each test can specify an instrument and type of test to run on the instrument. In addition, or alternatively, non-analytical test types such as sorting, positioning or parking can be specified. As tests are added to the test group, conditions and characteristics of the tests are also provided in the various columns of the table. For example, each test can have a description and a unique number assigned to it, based on entries in the columns associated with the given test. Various completion criteria can be added to each test group to indicate how a test within that group can complete, typically based on a status of the test status available from an instrument or device conducting the test. The user can input or select the completion criteria that can be used to determine when the test has completed. Some completion criteria may permit several runs of a sample on a given instrument before a completion criterion is met, for example. The setting of completion criterion for each test is illustrated in block 216.

Another column entry that is available for each of the tests is a priority band. Each test can be assigned a priority band that indicates how the tests should be ordered, and further indicates how the sequence of tests should be performed with respect to completion criteria. For example, a test with a certain, higher priority is executed before lower priority tests, and the lower priority tests are not executed until the completion criteria is met for the higher priority test. The setting of the priority band for each test is illustrated in block 218 of flow chart 200.

A number of other parameters can be set for each test in the created test group, as may be useful in organizing and executing tests in a group for a given sample. The different types of tests can have different associated parameters and/or criteria, which may be specific to the test, instrument or device upon which the test is run. For example, a sort test can be defined that causes samples in a given lane of the LAS to be ordered in a specific sequence, or cause certain samples to be delivered to specific locations or positions within a lane, for example. The completion criteria for such a test can be determined based on sensors that can process the lane location of a sample and position of the sample within a lane. Accordingly, the completion criteria for a sort test can be substantially different from that of an immunoassay test conducted on an instrument that can provide status information related to various runs of the immunoassay tests.

Each of the test groups can be stored for later use or recall. In addition, a number of standard test groups can be implemented to provide the users with the capability of retrieving a stored test group for implementing a standard test that may involve a number of specified tests on different instruments in the laboratory. The user interface or test group setup or template may provide default values for the various types of tests, including descriptions, identifiers, parameters and/or criteria that are pertinent to the given tests.

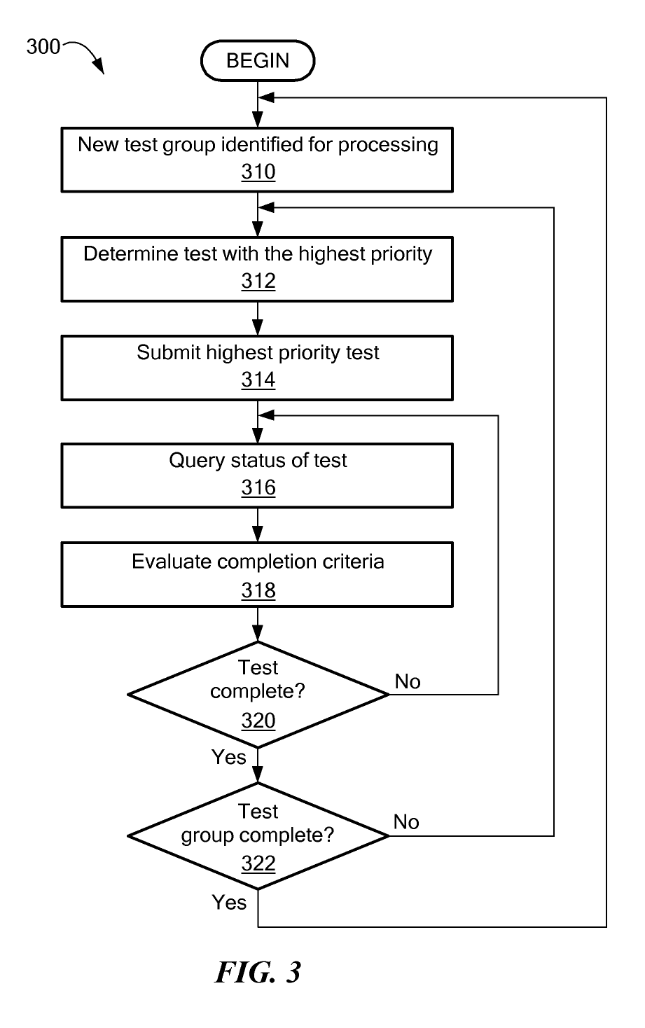

Referring now to FIG. 3, a flowchart 300 illustrates operation of an exemplary embodiment the disclosed systems and methods. In flowchart 300, a test group is submitted for processing to have tests conducted on samples by the laboratory equipment. A test group is identified by the system for submission and processing, as illustrated in block 310. The test group may be the current test group in a queue of test groups, or may be identified by a user as the next test group, or may be identified according to any number of other criteria or constructs that are useful in scheduling or presenting test groups for control of sample test processing.

The test group selected or presented for processing may have a number of tests listed with one or more priority levels or hands. The test in the test group with the highest priority is determined according to a general priority hierarchy, for example, by being associated with a certain number ranking. The priority of the test is set by the user in accordance with the setup of the test group, as is illustrated in block 218 of flowchart 200 (FIG. 2). If a number of tests have the same priority, they are all selected for submission to the respective instruments. For example, tests with the same priority may be expected to be run on different instruments, so that tests with the same priority can be run in parallel.

The unprocessed test(s) with the highest priority are submitted for execution on the instruments designated by the test criteria, as illustrated in block 314. The test definition provided in the test group can provide the criteria for the instrument on which the test is to be performed and the completion criteria for the test. The sample to be tested is then provided to the designated instrument in the LAS for aspiration and the testing can begin.

As the aspirated sample is tested, the instrument running the test is queried for or provides updated status information on the test, as illustrated in block 316. The status information is returned to the platform of the present disclosure, where it can be evaluated against completion criteria or test management logic or prioritzation, as illustrated in block 318. Decision block 320 illustrates the determination of whether the test is complete based on a comparison of the status information with the completion criteria for the test. If the test is not complete, the platform continues to gather status information from the instrument, as illustrated by the No branch of decision block 320 being directed to block 316 for additional status information retrieval.

If the test is determined to be complete, a determination can be made as to whether any further, lower priority tests are awaiting processing in the test group. This operation is illustrated with the Yes branch of decision block 320 being directed to decision block 322. If more tests are specified in the test group, the next highest priority test(s) are determined for implementation, as illustrated with the No branch of decision block 322 being directed to block 312 for additional test/priority determinations. If there are no more tests to execute in the test group, a new test group can be identified for processing, as illustrated with the Yes branch from decision block 322 being directed to block 310 for new test group selection.

With respect to the implementation of platform logic, including the specification of completion criteria, prioritization, scheduling, and any other tests management criteria, the settings and selections for the tests and test groups can be implemented by storing perimeters in a computer memory. The stormed perimeter values are retrieved and used by the platform logic to make comparisons with data obtained during tests execution, such as maybe provided by test, instrument or device status. This status information may be communicated using LAS 122 (FIG. 1), while the platform logic and perimeter values maybe stored and/or executed on DM server 120 (FIG. 1). The provision of the facility to store large numbers of perimeters for a given test of test group, and to evaluate those perimeter values against test, instrument or device status makes the presently disclosed systems and methods very flexible and highly useful for conducting test procedures on an automated basis that were previously done manually with significant challenges to the user related to proper tests sequence, result contingencies and other test related phenomenon that is difficult to track manually. Accordingly, once tests, test groups and related perimeters are set up, the platform and platform logic can be commanded to schedule or implement the tests within the test groups in accordance with the present disclosure.

Some examples of configuring workflows and the results of their executions are provided below.

### Example 1

In the following example a sample, ‘Sample1’ is assigned four tests, TestA, TestB, Teste and TestD. The user would like to specify that TestA should be completed and that the sample should be temporarily parked to permit the results of TestA to be determined, to permit a decision to be made as to whether TestB, Teste and TestD should be conducted. An assumption is made that TestB, Teste and TestD are not performed on the same instrument as TestA; otherwise these tests could be downloaded to the same instrument along with TestA and treated directly through instrument instruction.

The test configuration in accordance with the present disclosure can be provided as follows:
TestA is added to a test group with completion criteria that specifies obtaining a validated result from the test by the instrument. The listing of TestA in the test group can be assigned a priority band with a value of 10.
TestB, Teste and TestD are added to the test group with completion criteria that specifies a dependency on the completion criteria of TestA. Each of these tests can be assigned a priority band with a value of 20, e.g., a lower priority than TestA.
A Park Test is created in the middleware but need not be assigned any particular priority. The Park Test can be configured as a sort test to a particular lane in the LAS.
Global test routing option, ‘ASAP’ can be selected for tests not associated with any priority band. Such tests may be executed after all prioritized tests have reached their respective completion criteria, for example.

In this example, several scenarios may be possible. Scenario 1: the results of TestA are received, validated and the completion criteria are satisfied. TestB, Teste and TestD are then dispatched. When an order for ‘Sample1’ is received in the middleware, e.g., to physically obtain the sample, TestA and Park Test are dispatched to the LAS with an action code of N (New). Such an action code can be generated by the platform or platform logic of the present disclosure (e.g., the middleware) when a test or test group is presented for execution. The action code can be used by the LAS to implement TestA on the instrument specified for TEstA, and prepare any logistics in expectation of conducting the test, e.g., setting up the instrument for the test and/or providing the instructions for the test to the instrument.

The sample tube is routed to the instrument and the instructions or commands for TestA are downloaded to the instrument. The sample is aspirated from the sample tube, which is then routed to a parking lane (as the Park Test has been defined as a sort test without high priority in the LAS.

Once TestA results and moves to status ‘validated,’ then TestB, Teste and TestD are dispatched to the LAS with an action code of A (Add). At that point, the sample is automatically retrieved from the parking lane and routed to the instrument where Test B, Teste and TestD would be downloaded.

Scenario 2: the results of TestA are received, and are determined to meet a completion criteria in which TestB, Teste and TestD are not to be dispatched for testing.

When an order for ‘Sample1’ is received in the middleware, TestA and the Park Test are dispatched to the LAS with an action code of N (New). The sample tube is routed to the instrument and the instructions or commands for TestA are downloaded to the instrument. The sample is aspirated from the sample tube, which is then routed to a parking lane. Once the nature of the results of TestA are determined, TestB, Teste and TestD are omitted from the LAS, which may be achieved through execution of a rule programmed in the LAS, such as may be implemented as an Automatic rule. At that point, TestA is assigned a status of ‘validated,’ but TestB, Teste and TestD are not dispatched to the LAS since they were omitted by execution of the rule. In this Scenario 2, the test group configuration can be setup so that the Park Test is omitted from execution, resulting in a cancel order for the Park Test being sent to the LAS and the sample being moved to an output module.

### Example 2

In the following example a sample, ‘Sample2’, has four tests, TestA, TestB, Teste and TestD. The user would like to have TestA begin processing before some offline processing of the sample is performed. After such offline processing, which might be conducted by removing the sample from the automated environment, the user would then like to perform TestB, Teste and TestD on the sample. Those tests would use the track for automatic processing in the LAS, and so the samples are placed back into the automated environment after the offline testing. To accomplish this scenario the middleware can be configured as follows:
TestA is added to a test group with completion criteria that specifies scheduling of the test as a response to an instrument query for work. The entry of TestA in the test group can be assigned a priority band with a value of 10.
A Sort Test is added to the test group with completion criteria of sample location set to SortLane1 and associated with a priority band with a value of 11, which is lower in priority than 10.
TestB, Teste and TestD are added to the test group with completion criteria that specifies a dependency on the completion criteria of TestA. Each of these tests can be assigned a priority band with a value of 12, e.g., lower priority than the priority value assigned to TestA.
A Sort Test is created and configured as a sort test to a SortLane1 in LAS (non priority sort).
Global test routing option has no influence in this particular scenario as all tests on the sample are part of an automation priority group.

When an order for ‘Sample2’ is received in the middleware, TestA is dispatched to the LAS with an action code of N (New). The sample tube is routed to the instrument and the instructions or commands for TestA are downloaded to the instrument. The sample is aspirated and the status of TestA changes to ‘scheduled.’ The Sort Test is then dispatched with an action code of A (Add). The sample tube is then routed to the sorting lane associated with the Sort Test, SortLane1. The sample location update would be automatically sent to the middleware, which would now know that the sample has gone to the correct sorting lane.

The operator can then take the sample out of the sorting lane and perform the offline processing desired. Once the sample is reintroduced to the LAS, a message, such as an L001 Sample Receipt Notification (In-Lab) message, can be sent to the middleware, thus fulfilling the completion criteria for the offline processing or Sort Test. TestB, Teste and TestD can then be dispatched with an action code of A (Add) and the sample would be routed as required.

The priority bands discussed above can be linked to an LAS channel and permit LAS test groups to be assigned to a priority band. The priority bands contribute to ensuring that the tests/requests are dispatched to the LAS in a specific order. In addition, or alternatively, the priority bands help enforce certain trigger criteria for dispatching test requests. Each LAS channel can have one or multiple priority bands.

Test groups that contain one or more tests are associated with priority bands. The test groups also have “release” conditions that are configured to indicate when the test group is “complete”. The release conditions can be configured to be operative based on status information obtained from instruments, or based on location information for a sample, as might be pertinent for sorting or parking operations.

In addition, tests can be dispatched to the LAS that are not a part of any priority band. For example, after all the tests with priority bands have met their completion criteria, the non-banded tests can be dispatched in accordance with this configuration. Thus, tests with no associated priority band may be dispatched last, effectively being assigned a default lowest priority. Moreover, tests can have a priority parameter set to a value, such as ASAP, for example, which would result in all tests that are not in a priority band being dispatched first, or at the same time as the highest priority band. Tests can also have a specific value indication for priority. This feature can be used if the user wishes to dispatch non-priority banded tests after a specific priority band has met its completion criteria.

Settings can be provided on a test group basis or for individual tests to permit an associated priority band to be ignored. Such settings can be used to permit tests to be rerun, or to permit other criteria to control tests and test reruns, which criteria may be derived from the LIS.

The present disclosure provides a user interface for entry of information to configure and specify tests. According to an exemplary embodiment, the interface is conditioned with rules to restrict the user to permissible inputs or configurations. For example, the interface can range check inputs to ensure they fall within an acceptable range. The interface can indicate if an instrument is not available, so that tests that require a result from that instrument are prevented from being configured or executed.

Some of the completion criteria and status information messages are listed below.
Scheduled (SCH or higher): The test request has been included in a response to an instrument query for work.
ReRun (RRN or higher): A result for the test has been received but has since been rerun.
Review (REV or higher): A result for the test has been received at the middleware.
Validated (VAL or higher): A result has been received and validated, either automatically or manually, in the middleware. This means that a valid result has been obtained for the test.
Uploaded (UPL or higher): A result has been received, validated and uploaded to the LIS host
Omitted (OMT) A User or Automatic Rules have decided that the subject test requests in an Automation band are no longer required.
Pending (PND): The initial state of a request.

According to an exemplary embodiment of the present disclosure, priorities can be changed during the course of test execution, based, for example, on the outcome of a given test. Thus, tests can be added, reordered or omitted based on the outcome of tests or changes in status obtained from a given instrument. Facilities such as these can be flexibly implemented through the use of logic, sometimes referred to as business logic, that can provide the user with a number of variations for test execution in dependence upon status or other test execution criteria.

According to another exemplary embodiment of the present disclosure, the status information provided by the instruments can be obtained on a polling or query basis, or on an event driven basis. The polling or query can originate from one or more instruments or from a controller that implements the platform of the present disclosure. The event driven criteria can originate from one or more instruments, the controller, or any other device that can be used to indicate or observe an event. Such other devices can include timers or clocks, manual indicators (buttons, switches and the like) or any other type of useful device for indicating an event occurrence.

According to another exemplary embodiment of the present disclosure, test groups can be analyzed and/or divided by criteria related to the instruments used by the test group. For example, a first test group may use a certain instrument to execute the tests that are in the first test group. The instrument may be specified for a TestZ in a second, following test group, where TestZ has no dependencies on other completion criteria within the second test group. The platform of the present disclosure can then implement TestZ, on the available instrument while the tests of the first test group are also being executed. In this way, the operation of the LAS can be made more efficient and achieve potentially greater throughput by utilizing available instrument capacity.

The operations herein depicted and/or described herein are purely exemplary and imply no particular order. Further, the operations can be used in any sequence when appropriate and can be partially used. With the above embodiments in mind, it should be understood that they can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations depicted and/or described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed systems and methods can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The foregoing description has been directed to particular embodiments of this disclosure. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the function described herein may be performed by a processor executing program instructions out of a memory or other storage device. Therefore, it is the object of the appended claims to cover all such variations and modifications as come within the true spirit and scope of the disclosure.

What is claimed is:

1. A method for test implementation in a laboratory automation system (LAS), comprising:
obtaining a test group that includes one or more tests to be run on instruments in the LAS, each of the one or more tests being associated with completion criteria;
dispatching at least one test from the test group to the LAS for execution;
obtaining status information for the at least one test related to processing of the at least one test by a component of the LAS;
comparing the status information to the completion criteria associated with the at least one test to determine if the completion criteria has been satisfied in accordance with the status information; and
identifying the at least one test as completed upon the completion criteria being satisfied.

2. The method according to claim 1, further comprising:
determining, in accordance with priority information assigned to the one or more tests in the test group, a highest priority test included in the test group that has not been executed.

3. The method according to claim 2, further comprising:
dispatching the highest priority test to the LAS for execution.

4. The method according to claim 3, further comprising:
obtaining the status information from the LAS or a laboratory information system (LIS).

5. The method according to claim 1, further comprising:
scheduling the at least one test for execution in accordance with relative priority of the at least one test compared to priorities of other tests included in the test group.

6. The method according to claim 5, further comprising:
dispatching at least another test included in the test group for execution upon the completion criteria for the at least one test being satisfied, wherein the at least another test has a lower relative priority than the at least one test.

7. The method according to claim 1, wherein the at least one test is a non-analytical test.

8. The method according to claim 1, further comprising:
providing a global parameter value to indicate how tests in the test group for which no priority is specified should be executed.

9. The method according to claim 8, wherein the global parameter value indicates that tests for which no priority is specified are to be executed before or after tests for which a priority is specified.

10. The method according to claim 1, further comprising:
including LAS parameter values to the LAS when the at least one test is dispatched to the LAS for execution to permit the LAS to manage the at least one test according to the LAS parameter values.

11. The method according to claim 1, further comprising:
determining a relative priority of the test group such that a plurality of test groups can be scheduled for prioritized execution.

12. The method according to claim 1, further comprising:
modifying the test group in accordance with an outcome of the at least one test identified as being completed.

13. The method according to claim 12, further comprising:
one or more of adding, reordering, omitting or changing a priority of a test in the test group in accordance with the outcome of the at least one test identified as being completed.

14. The method according to claim 1, further comprising:
obtaining another test group for execution after all the tests in the test group are identified as completed.

15. A system for test implementation in a laboratory automation system (LAS), comprising:
a processor coupled to a memory and operative to access and execute instructions in the memory to:
obtain a test group that includes one or more tests to be run on instruments in the LAS, each of the one or more tests being associated with completion criteria;
dispatch at least one test from the test group to the LAS for execution;
obtain status information for the at least one test related to processing of the at least one test by a component of the LAS;
compare the status information to the completion criteria associated with the at least one test to determine if the completion criteria has been satisfied in accordance with the status information; and
identify the at least one test as completed upon the completion criteria being satisfied.

16. The system according to claim 15, wherein the processor is further operative to:
determine, in accordance with priority information assigned to the one or more tests in the test group, a highest priority test included in the test group that has not been executed.

17. The system according to claim 16, wherein the processor is further operative to:
dispatch the highest priority test to the LAS for execution.

18. The system according to claim 15, wherein the processor is further operative to:
schedule the at least one test for execution in accordance with relative priority of the at least one test compared to priorities of other tests included in the test group.

19. The system according to claim 18, wherein the processor is further operative to:
dispatch at least another test included in the test group for execution upon the completion criteria for the at least one test being satisfied, wherein the at least another test has a lower relative priority than the at least one test.

20. The system according to claim 15, wherein the at least one test is a non-analytical test.

21. The system according to claim 15, wherein the processor is further operative to:
determine a relative priority of the test group such that a plurality of test groups can be scheduled for prioritized execution.

22. The system according to claim 15, wherein the processor is further operative to:
modify the test group in accordance with an outcome of the at least one test identified as being completed.

23. The method according to claim 16, wherein the processor is further operative to:
one or more of adding, reordering, omitting or changing a priority of a test in the test group in accordance with the outcome of the at least one test identified as being completed.

24. The method according to claim 15, wherein the processor is further operative to:
obtain another test group for execution after all the tests in the test group are identified as completed.

25. A method for preparing tests for implementation in a laboratory automation system (LAS), comprising:
specifying a test group that includes one or more tests to be run on instruments in the LAS;
assigning completion criteria to at least one test in the test group, the completion criteria being specific to the at least one test and execution of the at least one test;
assigning a priority to the at least one test in the test group, such that tests in the test group can be executed in order based on assigned priority.

26. The method according to claim 25, further comprising:
assigning a group priority for the test group such that test groups can be executed in order based on assigned group priority.

27. The method according to claim 25, further comprising:
creating at least one dependency for another test in the test group, such that treatment of the another test depends upon an outcome of the at least one test upon the completion criteria being satisfied.
